(19) United States
(12) Patent Application Publication
(10) Pub. No.: US 2002/0065697 A1
(43) Pub. Date: May 30, 2002

(54) Method and apparatus for project evaluation, approval and monitoring

(76) Inventors: Paul C.R. Cautley, Eden Prairie, MN (US); Paul A. Elletson, Eden Prairie, MN (US)

Correspondence Address: Daniel G. Chapik, DORSEY & WHITNEY LLP, Suite 1500, 50 South Sixth Street, Minneapolis, MN, 55402-1498, US

(21) Appl. No.: 10/010,145

(22) Filed: Nov. 8, 2001

Related U.S. Application Data
(60) Provisional application No. 60/247,822, filed on Nov. 9, 2000.
(60) Provisional application No. 60/247,483, filed on Nov. 10, 2000.

(51) Int. Cl. G06F 17/60

(52) U.S. Cl. 705/7

(57) ABSTRACT

A proposer formulates an idea for a proposal and enters various proposal parameters into a project summary screen, forming a proposal. The proposal is electronically submitted and stored. Once submitted in a final version, the proposal is frozen by the system, so that subsequent review by any number of reviewers is conducted based on the same proposal parameters. The reviewers each review the same material and may offer comments. Those comments can be shared with other reviewers, through the system. A decision is made and entered into the system. If accepted, the proposal moves forward and becomes a project. Project status is tracked based on automatic comparison to previously approved parameters. If not accepted, the system may unfreeze the proposal and allow revision. The system can utilize a network configuration so that the proposer, reviewer and other participants can share and exchange information remotely from one another.

### CROSS-REFERENCE TO RELATED APPLICATION(S)

This application claims priority from U.S. provisional application No. 60/247,822, filed Nov. 9, 2000, and U.S. provisional application No. 60/247,483, filed Nov. 10, 2000, both entitled, “METHOD AND APPARATUS FOR PROJECT EVALUATION, APPROVAL, AND MONITORING,” by Paul Cautley et al., which are hereby incorporated by reference in their entirety.

### TECHNICAL FIELD

The present invention relates to a method and apparatus for the tracking of information.

### BACKGROUND

As the size of a company increases in terms of personnel and service varieties, a company may have more difficulty keeping itself organized in a variety of different areas. A lack of organization can hurt the company's effectiveness from areas as unrelated as payroll, hiring, and the services it offers its customers. One important area that may become more difficult to organize in an effective manner as a company grows in size may be its project proposals. Project proposals include both internal and external proposals, and those in both the planning stage or the implementation stage. Tracking these proposals may be difficult in both the evaluation and implementation stages.

A company's size is not the only determining factor in whether a company has a problem keeping track of proposals in the evaluation or implementation stages. The number of proposals and the number of the people who are required to review the proposals may also be a hindrance to proposal management. The greater the number of people that must evaluate a proposal may make it more difficult to achieve the review in a timely manner; in addition to forming a consensus on whether a project should be implemented, continued, or sent back to the proverbial drawing board. Furthermore, as the number of new and implemented proposals grows, it may have a deleterious effect on the tracking and implementation of each proposal.

In today's business world, many companies are organized so more than one person reviews any proposal that would require a threshold commitment in personnel, resources, and capital. Having more than one person to review a project proposal allows a company to utilize a range of different backgrounds and specialties to better evaluate a proposal or ongoing project. A project reviewer from one department may have a completely different view on the value of a proposal, or the continuation of an undertaking, than a reviewer from different department; this may also hold true for reviews from geographically diverse areas as well. Bringing together reviewers from different departments or geographic areas for a face to face meeting may pose logistical difficulties.

After a proposal has been approved for implementation, it becomes an ongoing project. The project may then be reviewed on a periodic basis to check to see if it is meeting its goals and performance criteria as set out in the proposal. Continually refining the project's strategies, and sometimes its goals, is often necessary. Each time a project is changed, however, may affect the opinion of the various reviewing members.

### SUMMARY OF INVENTION

A proposer formulates an idea for a proposal and enters various proposal parameters into a project summary screen, forming a proposal. The proposal is electronically submitted and stored. Once submitted in a final version, the proposal is frozen by the system, so that subsequent review by any number of reviewers is conducted based on the same proposal parameters. The reviewers each review the same material and may offer comments. Those comments can be shared with other reviewers, through the system. A decision is made and entered into the system. If accepted, the proposal moves forward and becomes a project. If not, the system may unfreeze the proposal and allow revision. The system can utilize a network configuration so that the proposer, reviewers and other participants can share and exchange information remotely from one another.

In one embodiment, a method for tracking projects is provided that comprises providing a project summary screen; receiving proposal parameters; freezing the proposal parameters; presenting the proposal parameters to at least one reviewer; and receiving a decision regarding the proposal parameter from the at least one reviewer.

In one embodiment, the method may also include receiving revisions to the proposal parameters prior to freezing the proposal parameters and/or receiving a designation of reviewers. The method may further include receiving comments from the at least one reviewer regarding the proposal parameters; storing the comments with the proposal parameters; and presenting the comments along with the proposal parameter to a subsequent reviewer.

### BRIEF DESCRIPTION OF THE DRAWINGS

FIG. 1 is a block diagram of a high level architecture consistent with the principals of the present invention.

FIG. 2 is a block diagram of a server set up consistent with the principals of the present invention.

FIG. 3 is a flow diagram of 87 evaluation and approval portion consistent with the principals of the present invention.

FIG. 4 is an example of a welcome page for one embodiment consistent with the principals of the present invention.

FIG. 5 is an example of a project list page for one embodiment consistent with the principals of the present invention.

FIG. 6 is an example of a projects pending approval list for one embodiment of the present invention.

FIG. 7 is an example of a portfolio review page for one embodiment of the present invention.

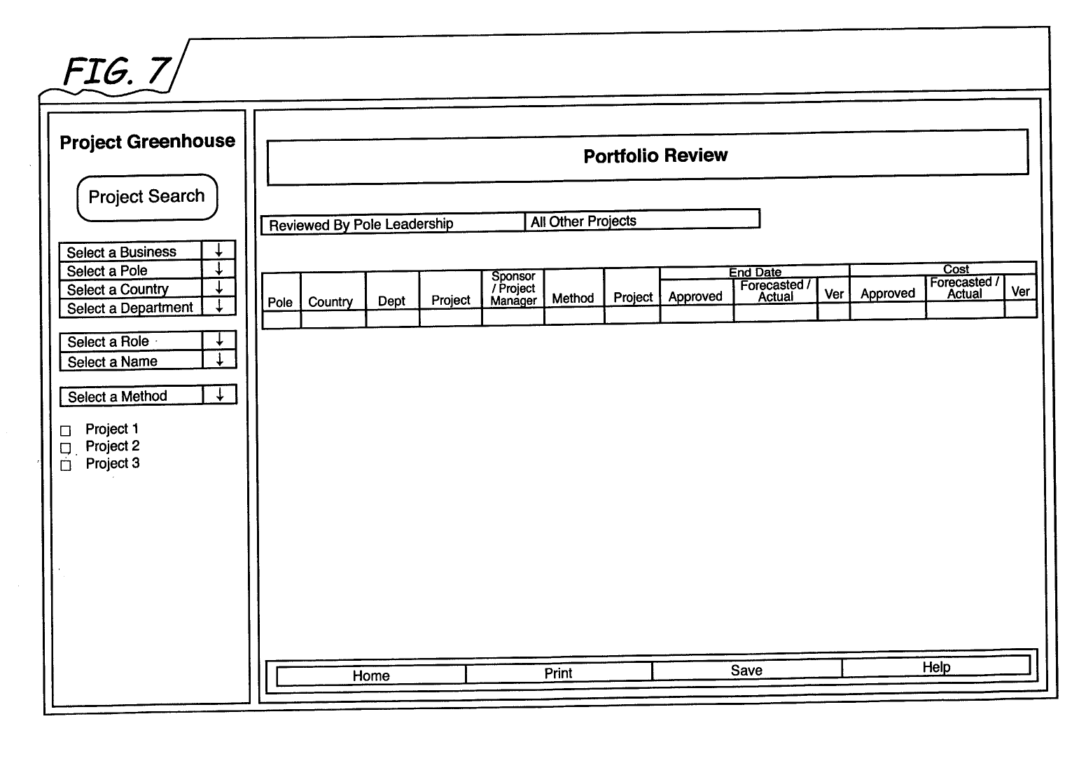

FIG. 8 is an example of a summary sheet for one embodiment of the present invention.

FIG. 9 is an example of project documents attached to a proposal for one embodiment of the present invention.

FIG. 10 is an example of a first page of an alternative embodiment of a project summary page.

FIG. 11 is an example of a second page of the alternative embodiment of the project summary page of FIG. 10.

FIG. 12 is an example of a project approval sheet for one embodiment of the present invention.

FIG. 13 is an example of an attachment to the project approval sheet for one embodiment of the present invention.

FIG. 14 is an example of a project status sheet for one embodiment of the present invention.

FIG. 15 is an example of a project history sheet for one embodiment of the present invention.

### DETAILED DESCRIPTION

The present invention description describes an apparatus and method for project evaluation, approval and monitoring. One embodiment of the present invention provides a high level view of overall parameters of one or more submitted proposals; alternative embodiments may be utilized which require the input of more information. The present invention is described herein in terms of the evaluation and tracking of new proposal and the project that results from that proposal.

The project the proposer submits will be referred to herein as the “proposal.” The individual or group of individuals that propose the project will be referred to herein as the “proposer.” A proposal that has passed through the review stage and is being implemented will herein be referred to as “project” or “ongoing project.” The individual and/or group of individuals that review the proposal and/or ongoing project will be known as the “reviewer” or the “reviewers.” These terms are only intended to be helpful in describing various embodiments and are not intended in any way to limit the scope of the present invention. Proposals may alternatively be referred to as “charters.” Charters is a term that is often used to describe projects from the proposal stage through the various levels of implementation. Charters indicate the ongoing and changing nature of a project's parameters.

As may be appreciated, a company utilizing the present invention method and apparatus may not necessarily be a for profit undertaking. As may be appreciated by one skilled in the relevant art, the company using the present invention may be any type of business or organization that requires a better system for the review and tracking of proposals for projects.

The present invention is described in terms of use over the Internet, but may also be utilized and implemented through an intranet or some other linked computer system. Each proposal and reviewer may be linked with a central database that stores, tracks, and distributes information on the proposals.

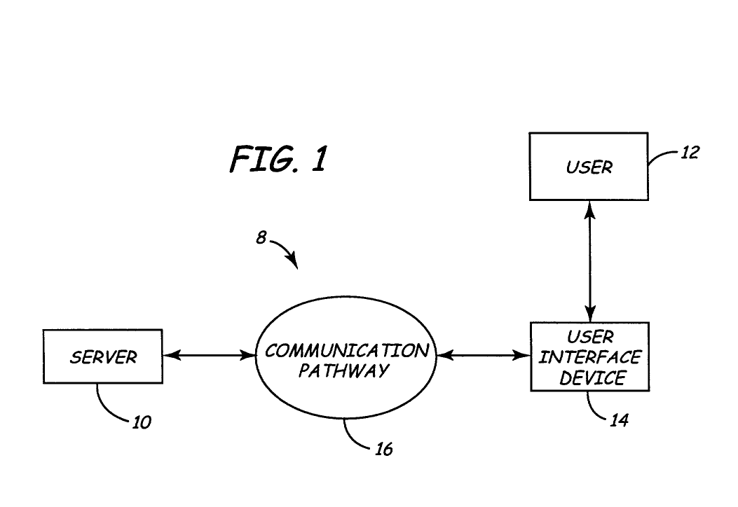

FIG. 1 is a block diagram illustrating a network 8 based on a client-server model. The network comprises one or more servers 10, at least one user 12, a user interface device 14, and a communication pathway 16. Each user 12 may have his or her own interface device 14 or the interface devices 14 may be shared, depending on the company's policy and the proposer's job. The proposers and the reviewers communicate with the servers 10 over the communication path 16 via the user interface device 14. User simply refers to any proposer or reviewer who is using the computer to access the present invention system. The communication pathway 16 may be through the Internet an intranet, or other suitable telecommunications paths. A suitable network protocol, such as the TCP/IP protocol, may be used for the communications. The interface device 14 may be any computer or web interface device known to those skilled in the art. The server 10 may include the web server, which provides the computer information. The web server and the database server may exist within a single computer or computer system, or can also be separate entities. This specification will refer to both possibilities as server 10. The server 10 allows access by the proposers and reviewers to various network resources through the communication pathway.

The interface device 14 may be any conventional computer known to those skilled in the art. The computer may comprise a central processor unit (“CPU”) and main memory, an input/output interface for communicating with various databases, files, programs, and networks (such as the internet), and one or more storage devices. The storage devices may be disk drive devices or CD ROM devices. The computer may also comprise a monitor or other screen device and an input device such as a keyboard and/or a mouse. In order to carry out the present invention over the Internet, the computer may need to have some software programs contained in the main memory or the storage which can be used by the CPU.

A web browser, which is a known software tool used to access the Web via a connection obtained through an Internet access provider, may be part of the software programs utilized. A variety of browsers known to those skilled in the art may be used. As explained above, a Web server may allow access to so-called “Websites” and “Web pages.” Once the Web browser has accessed these pages through the Web server, the page may be downloaded through the input/output interface. The central processing unit will use the browser software package to interpret the information and display it on the monitor. The software may also contain other software or programs which will allow the user to fill in information on the screens and to exchange data with the server.

The memory or the storage device may also contain configuration software. This software will enable the computer to configure the downloaded Web page to make it an interface device. The configuration software may allow a user to move from one field to another on the downloaded Web page to select options or enter usage information.

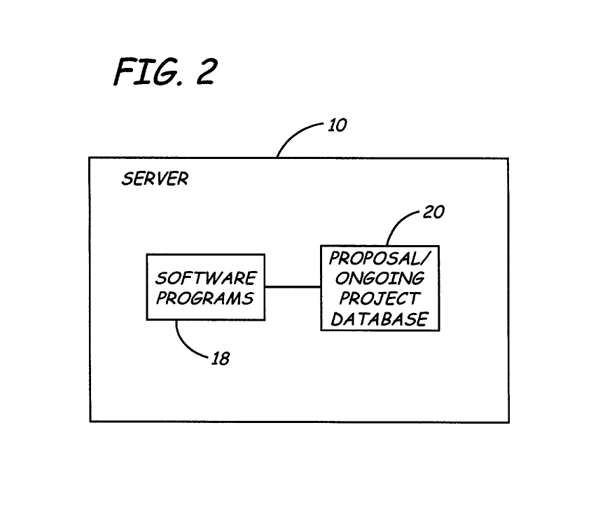

FIG. 2 is a block diagram illustrating one embodiment of the server side. The server 10 contains programs 18 that run on the server-side to process requests and responses from the proposer's or reviewer's interface, which sends the proper information to the proposer or the reviewer, and performs compilation and storage functions. In one embodiment, the server may send out web pages in HTML and/or Java script format for the user to download, interpret with his/her computer, and view on the monitor.

The server 10 may further contain software programs 18 that control the interface 14 with the communications pathway 16 of FIG. 1. The server 10 may further control the operations of the database 20 and the compiling of the proposals, and related proposal information, for evaluation by the reviewers.

The software 18 that runs the system may be located on the server 10. The computer may query the server 10 and the server 10 may provide the user computer with the screens, in whatever format, for display to the user through the configuration software 18 described above. Other software for the freezing of proposals, storing of information, and communication between reviewers, which is further described below, may also be incorporated into the server side as well.

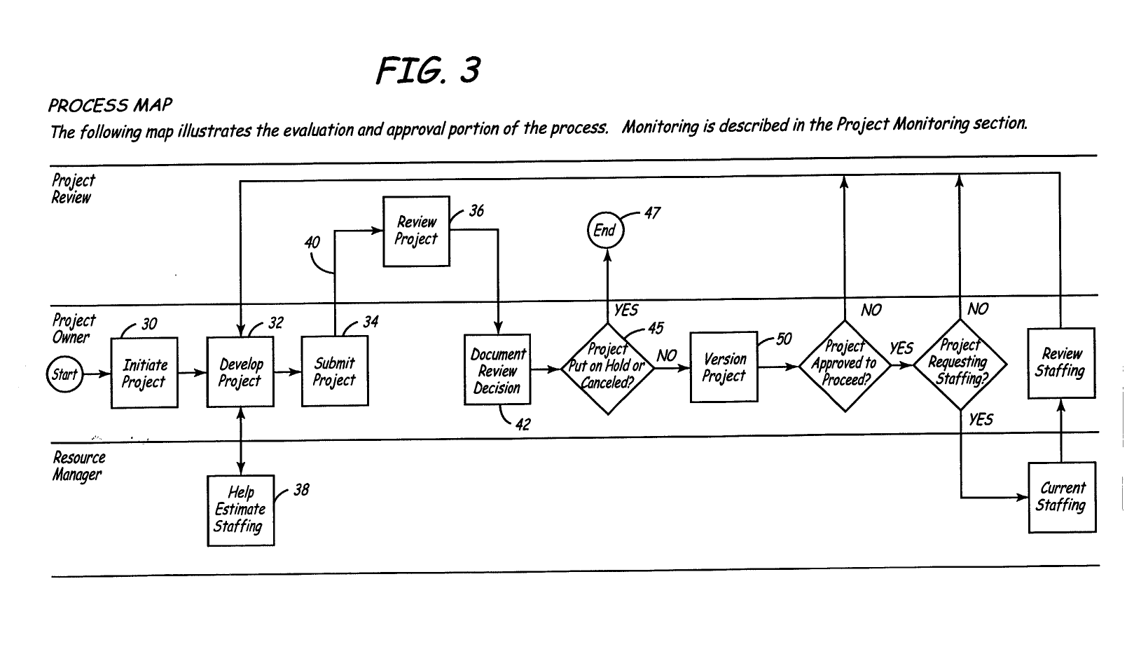

FIG. 3 is a process map illustrating one embodiment of the present invention. The proposer initiates 30 the proposal by forming an idea, developing the idea 32, and submitting 34 it. The proposal may relate to any facet of business, internal or external, that may need funding, personnel, etc. The reviewers will analyze 36 the proposal and decide whether the proposal meets criteria set by company policy and whether it merits the personnel, resources, and other tools required for implementation. Criteria for reviewing a proposal may be specific to each company. If the proposal is approved, the company may then commit the staffing and other resources required for implementation.

Before the proposal is submitted 34, the proposal must first be formed from an idea or concept into specific parameters 32. To form the proposal the proposer may define a solution for a need, establish a goal and a manner or achieving that goal, etc. The proposer may develop the proposal by working with various departments and resource personnel 38. The proposer may work with a finance group to confirm how the costs of moving to the next project phase will be covered, how the proposal's projected business benefits will be tracked, and whether any corporate or higher level approvals are required. The resources the proposer taps to formulate the proposal may help the proposer estimate the cost in personnel and capital the project may require. The proposer may continue to refine the proposal goals and limitations, including defining the implementation time of a project resulting from the proposal.

As the proposer establishes the goals, needs, and implementation for the proposal, the information may be entered through a computer for collection and storage on the database 20. The entirety of the information for the proposal may be referred to herein as “proposal parameters.” Once the proposal has been approved for implementation and assigned resources, the proposal parameters for the ongoing project become the “project parameters.” In order to enter information into the present invention system, the user 12 must first access the system with a computer.

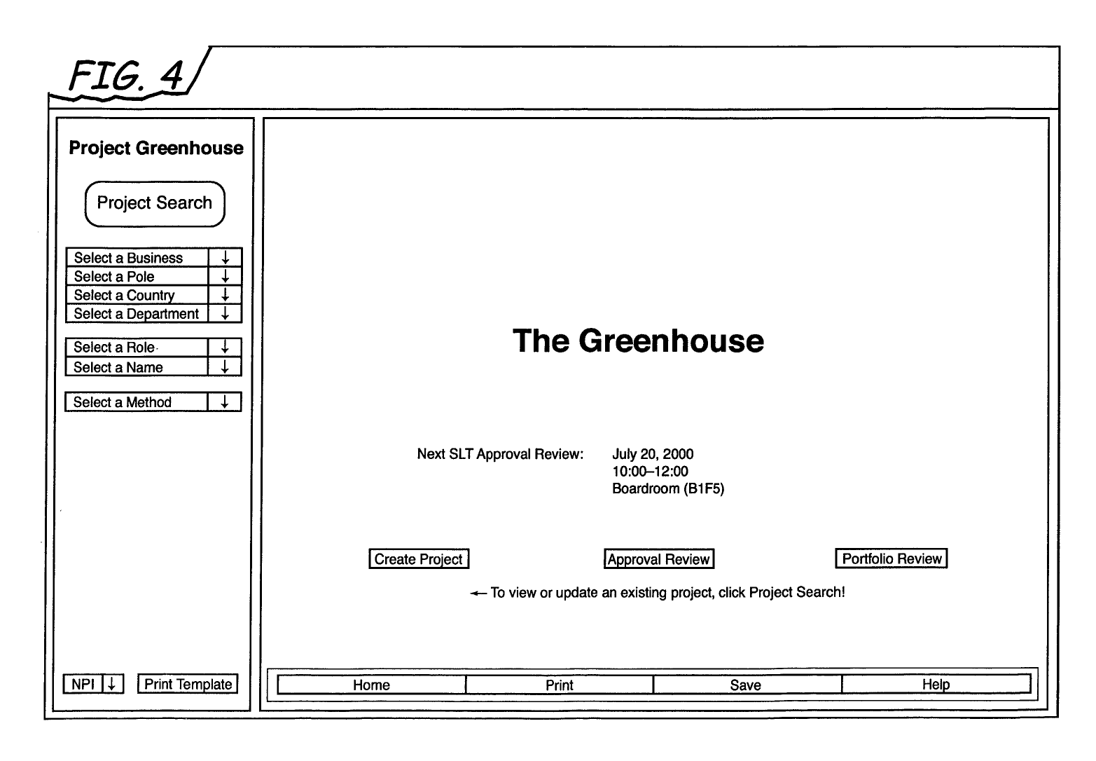

In one embodiment a screen may be provided that allows the user 12, whether a proposer or a reviewer, to log onto the system and select a function to perform (not shown). This screen may appear as any standard login screen well known to the users of computer systems. The login screen may allow the user to enter an identification and a password that indicates to the database who the user is, what the access the user has, etc. As illustrated in FIG. 4, a welcome screen which the user is presented with after correctly entering the identification and password. Once logged on to the system, the proposer may then begin to enter information to form the proposal. Other options for the welcome page may include searching capabilities for searching for a project by business area, pole, country or other parameters.

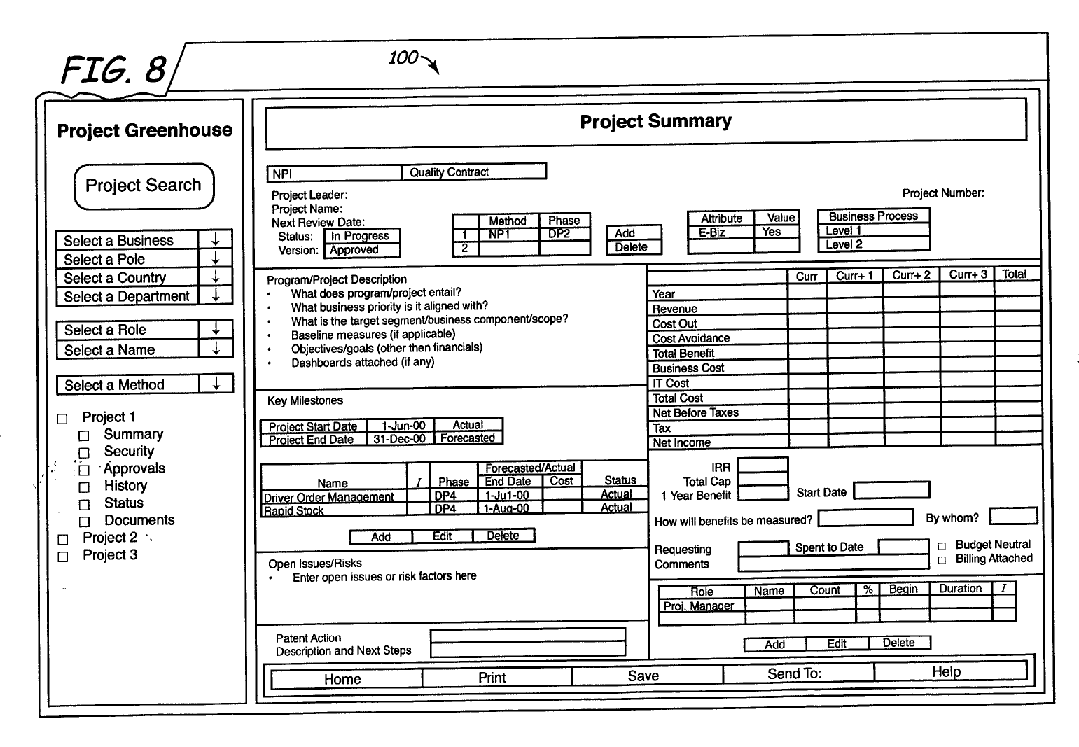

FIG. 8 illustrates a project summary screen. The project summary screen may be accessed if the user 12 has elected to submit a new proposal, or edit an existing proposal. At various times, certain parameters of a proposal or project may be unaccessible to certain users because the proposal or project is being evaluated.

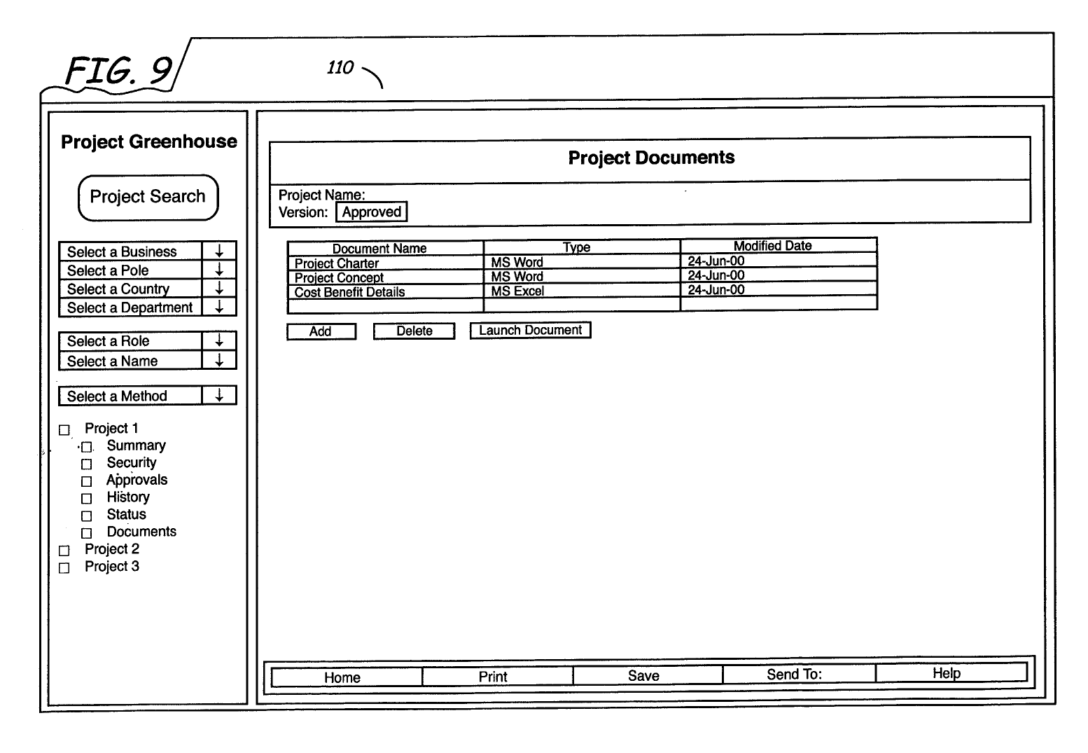

The project summary 100 may help the proposer formulate and put together the required information to submit the proposal. The project summary may comprise places to insert information such as a named proposal leader, proposal name, at least one proposal review date, a projected revenue amount, a projected capital investment amount, a proposed set of project measuring criteria, etc. As illustrated in FIG. 9, the proposal project summary 100 may also include project document screen 110 having a sheet for placing and attaching documents that relate to the proposal. As may be appreciated, the project summary 100 may further facilitate the tracking of an ongoing project. In alternative embodiments it also may be possible to submit an existing word document form that can then be pasted or attached into the summary screen, whether automatically or manually.

Once the proposer feels that the proposal has reached a stage where it is ready for submission to the one or more reviewers, the proposal parameters may be entered, if they have not been entered already, onto the project summary screen. As may be appreciated, the proposal parameters tracked by the present embodiment project summary sheet may not have application for each and every proposal, so the various proposal parameters on the project summary sheet may be varied depending on the nature of the company's business. Furthermore, depending on the nature of the proposal, one or more of the areas for the addition of information which comprises the overall set of proposal parameters may be left blank. For example, if a proposal is for an organization to perform some sort of community service, or to donate resources to a worthy cause, the projected revenue areas will be left blank because no revenue would be generated by such a project. Furthermore, if utilized by a company that strictly performs non-profit or charitable work, the projected revenue blank might not exist in the utilized embodiment since it may be rarely needed. Alternative embodiments may have various project parameters requiring a variety of different information depending on the nature of the company's business and the type of proposal. Furthermore, the high level view provided by the project summary screen of the present invention may provide an easily accessible and easily evaluated high level of the overall proposal and the overall project that results from the proposal.

When the proposal is formally submitted, the system notes the submission and freezes 40 (FIG. 3) the proposal parameters. Freezing the proposal parameters means that the system will no longer allow the proposer, or anyone else, to change the proposal parameters until the completion of some designated event. In the present embodiment freezing is accomplished by the server 10 locking out any changes to the submitted proposal document. The submitted proposal is saved on the server 10 in the form in which it was submitted. It may be possible for the proposer at this time to make a new version of the submitted proposal to continue working on the idea, but the form in which it was submitted for review will remain the same until the review is completed.

In alternative embodiments, the proposer may have a copy of the submitted document downloaded onto his computer that can still be accessed and changed. The proposal frozen on the server, however, generally cannot be changed until such time as an update of the proposal is warranted. Alternatively, the proposal may be able to access and change on the server another copy of the submitted proposal, but the submitted proposal will still be frozen until the proposal is reviewed (or in an ongoing project, the ongoing project is reviewed and allowed to continue).

In one embodiment, the designated event before the proposal is unfrozen may be a review by the reviewers 36 (FIG. 3) and the entry of a decision 42 (FIG. 3) regarding the proposal. Either a portion of or all of the designated reviewers may have to review the proposal before it may be implemented depending upon the business using the system. In some instances, a face to face meeting will decide the ultimate fate of the proposal. Freezing the parameters means that the information on the summary sheet is saved in the manner in which it is submitted. Unfreezing simply means that a copy of/or the actual proposal parameters may now be accessed and changed by the proposer or another appropriate party. The frozen proposal, however, remains in its original submitted form on the server, and may be retrieved at anytime during the approval and implementation phases of the project for review.

Freezing the project parameters upon submission of the proposal for consideration provides certain advantages. Once the proposals are entered onto the database and the project is frozen, each reviewer is guaranteed access to the same proposal parameters, including personnel requests, funding requests, proposal goals, proposal evaluation criteria, etc. Each reviewer therefore reviews the same proposal comprised of the same proposal parameters.

Ensuring that each reviewer has access to the same proposal parameters may provide greater efficiency in the review process. If the project were not frozen in its submitted form, each reviewer may not review the same proposal parameters when the reviewer accesses the database since each reviewer is not reviewing the proposal at the same time. The frozen project is given a name and an identification and each reviewer can be assured of reviewing the same proposal as the other reviewers. Time is not spent ascertaining what information was available to which reviewer when each reviewer made his or her decision. Reaching a decision incorporating the comments of different reviewers is often difficult, and may be even more difficult when each reviewer is not making decisions based on the same proposal parameters. A proposer may eventually be allowed to resubmit the proposal after changing the project parameters in order to incorporate the comments of the reviewers, but until that time the reviewers are assured they are working with the same proposal parameters and communicating on the same level.

When the project is frozen, the proposer might not be allowed to change the proposal parameters. In one alternative embodiment, however, the proposer is allowed to copy the project summary over into a new project summary sheet, which is then updated in response to the comments by the reviewers. The reviewed proposal will have revised proposal parameters and may be submitted as a revised proposal. Updating a submitted proposal in this way may speed up the re-submission of a proposal that has merit, but requires changes in the implementation strategy, personnel, and other factors.

As may be appreciated, the system may be able to handle a large number of proposals at any given time, organizing them in a fashion that is easily reviewed by the reviewers. In alternative embodiments, the system may be managed under terms of the number of proposals each proposer is allowed to submit. In still further embodiments, a proposer may be restricted to one proposal, or version of a proposal, until the proposal has had a chance to go through the system; a variety of different ways to manage and implement the system may be known to those skilled in the art and utilized without changing the nature and scope of the present invention.

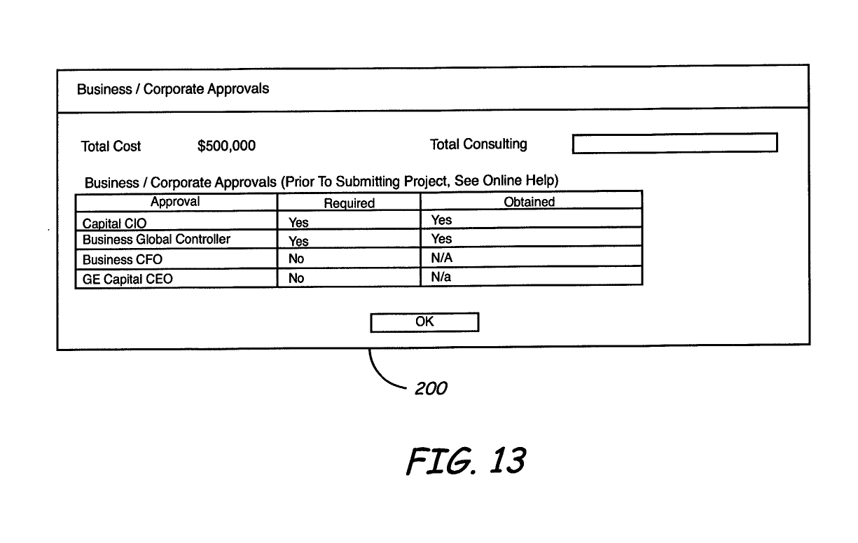

After a proposal is submitted and frozen, the proposal may then be reviewed 36 (FIG. 3). The review is usually done by a set group of individuals who may have responsibility for certain types of proposals. In one embodiment the designated review group may be arrived at by plugging the parameters of the proposal into a predetermined formulation, such as capital cost, projected revenue, area of implementation. In further embodiments, the review and approval of the proposal may require the signature of an executive officer of a division, such as the chief financial officer, a vice president, or some other person with the authority to commit significant company resources. FIG. 13 show a drop down page 200 listing various officers that may be required to approve a proposal dependent upon proposal costs.

In an alternative embodiment, of for proposals that do not meet the above formulations, the proposer may select the people who need to review the proposal before the submission of the proposal. Allowing the selection of reviewers may ensure that the proposal is reviewed by those who have expertise in the specific areas of the proposal. Selection of reviewers may further be advantageous if a proposal has more impact on a particular country or pole; reviewed by reviewers associated with the pole or country where the project will be implemented may make better economic and business sense. (As used herein, the pole may be the geographic area, i.e. continent, hemisphere, etc., where the proposal originates from).

Determination of what types of projects may customize the reviewer group may be set in a variety of different ways, including money spent, personnel required, and what goal or problems the proposal is addressing. In alternative embodiments, the system may have a gatekeeper who is assigned to help proposers refine and submit their proposals to the proper set of reviewers.

As illustrated in FIG. 9, the tracking system may include attached documents. Utilizing the resources of the internet and document transferal systems, each project summary may be supplied with an area that contains links to further information. The amount of information that is supplied with a proposal may be limited depending on the type of the proposal, the list of reviewers, and the amount of capital and personnel the proposal requires. The attached documents may be accessed by the reviewer to better understand the project if the reviewer feels more information is required than appears on the project summary sheet. As may be appreciated, reviewers may require more information for proposals that require more capital investment by the organization and less information for proposals that do not commit as much of the company's resources. Furthermore, reviewers who feel that more information is required may request additional information be posted in these areas for access by each reviewer.

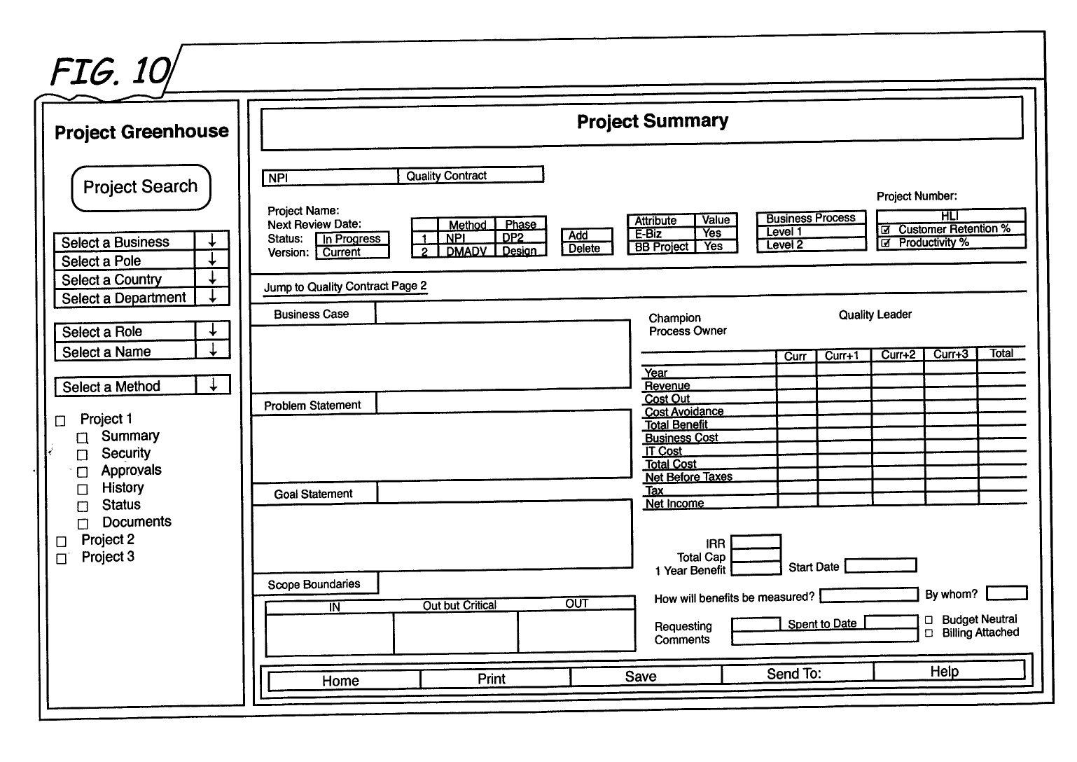

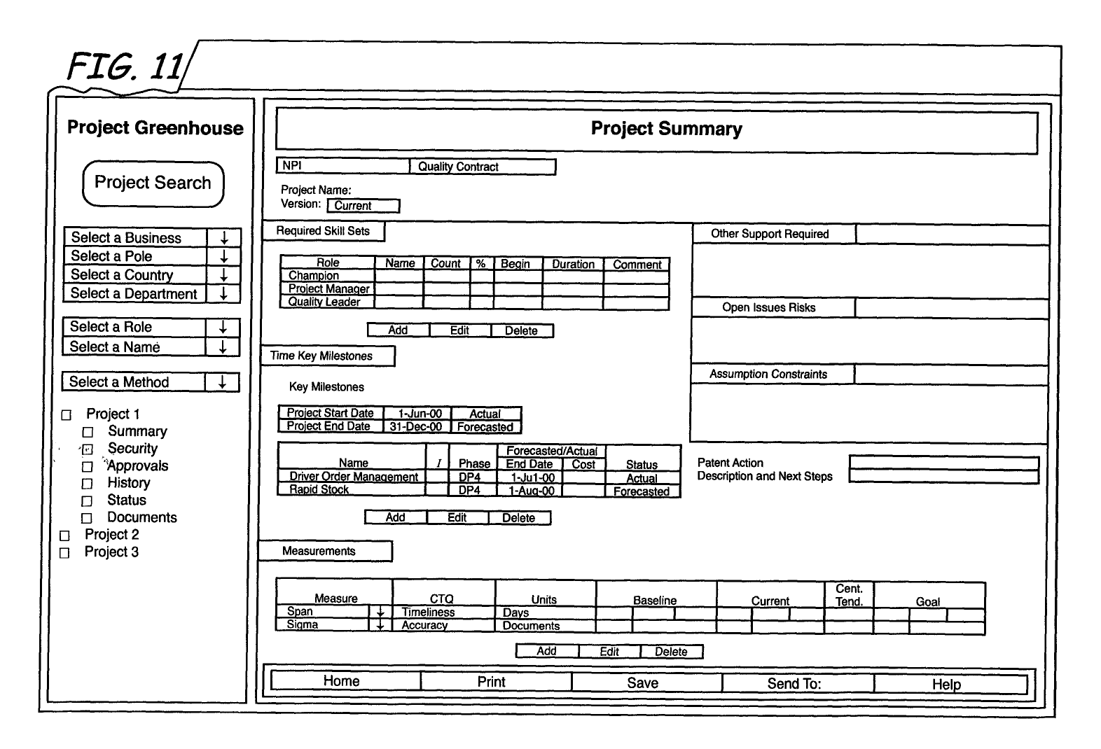

FIGS. 10 and 11 illustrate alternative embodiment project summary screens that may be used separately or in conjunction with that of FIG. 8. These screens may be different methods of keeping track of the same or similar information as the summary screen shown in FIG. 8. Depending on the route the proposer is taking to work up the proposal into a form for submission, it might be easier to use a different format for the information. FIGS. 10 and 11 may be for a quality contract, having significant overlap in the information presented, but presented in such a manner as to emphasize a different set of priorities. Filling out an overlapping section on one project summary screen simultaneously updates the corresponding section on other alternative embodiment summary screens.

A reviewer may enter the system to review proposals or to review ongoing projects. The reviewer may first enter an identification and password. After entering the identification and password, the reviewer may then go to the welcome screen shown in FIG. 4.

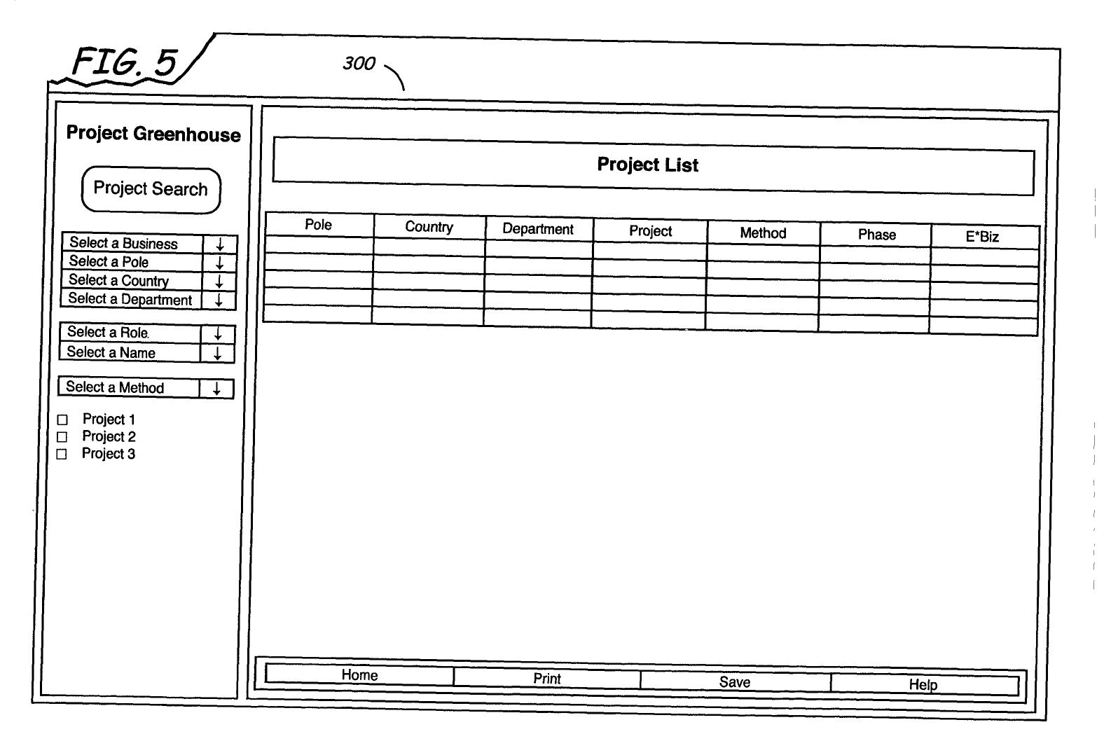

FIG. 5 illustrates a project list 300 for displaying the proposals entered into the present invention. The spreadsheet format of the project list 300 may include several different parameters and indices about a project that may be used for identification, such as a pole, a country, a department, etc. Identifying these parameters on a project list may allow each reviewer to easily view what proposals are in his or her area of responsibility and which need to be reviewed. Project list 300 may list all of the projects that are currently listed in the system.

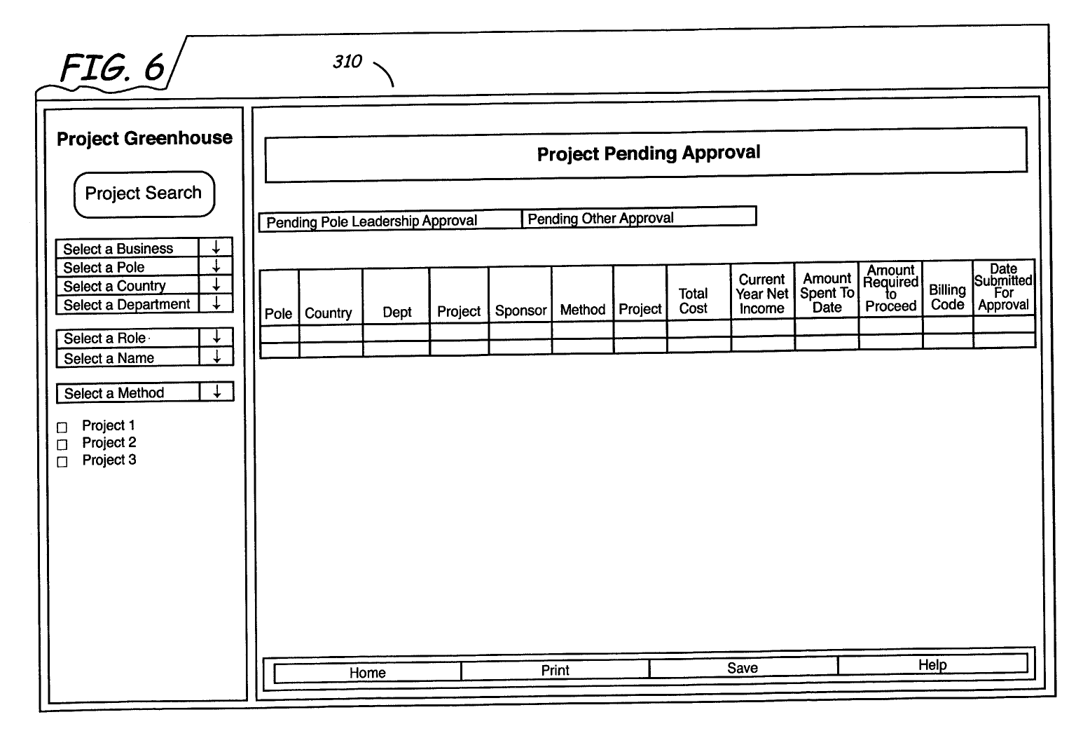

A project pending approval screen 310 is illustrated in FIG. 6. This screen 310 may list proposals that are still pending approval from one or more reviewers. The identification and password may allow the user access to different screens, and may cause different information to be displayed on those screens. Some proposals may be considered highly confidential and so therefore may only be listed on certain restricted screens.

As with any review, interaction among the people reviewing the proposal may be helpful. With larger and larger companies that may have reviewers in strategically important areas throughout the world, meeting to discuss one or more proposals may be costly and time consuming. With modern conference calling and teleconferencing, this difficulty is minimized, but not eliminated. The system presents an alternative, allowing reviewers to pool their comments and trade thoughts without ever having to meet face to face, or schedule a live conference call. The system allows each reviewer to submit their comments into a central database through a link to the project summary page. As may be appreciated, a review by every designated member may not be required, and a face to face meeting may be desirable in some instances. Furthermore, the system may be used as an easy access and familiarization tool for reviewers to be used before face to face meetings.

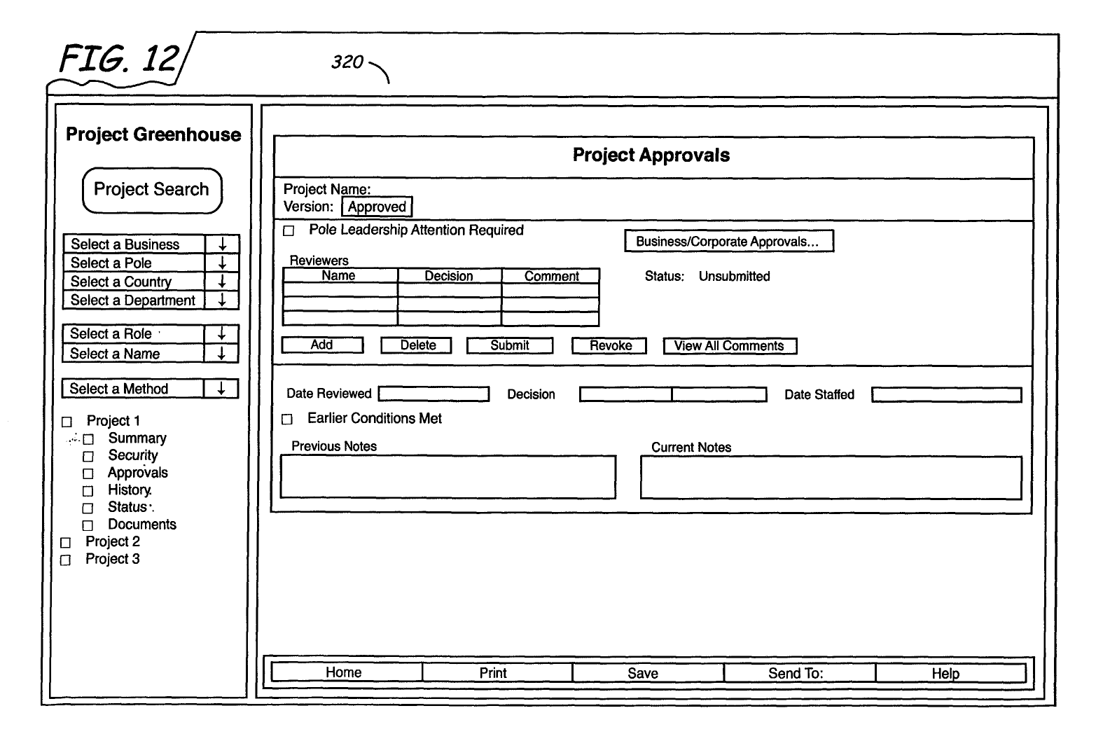

A project approval screen 320 is illustrated in FIG. 12. As illustrated the reviewer may submit comments through this screen. The project approvals screen 320 may have such fields comprising a proposal as version name, review meeting notes, including notes from the previous and current review, the names of the reviewers, a date the proposal was reviewed and an ultimate decision of the review board. Furthermore, the project approvals screen 320 may list all of those responsible for reviewing the proposal and the already entered comments of those who have entered them. In an alternative embodiment, an integrated scoring system may be utilized to rate projects according to preset criteria. These preset criteria may be embedded into a system for reviewer use, or available to each person who accesses the system depending on the set up of each particular embodiment.

The decisions of the assigned reviewers may be illustrated on a separate approval page. In alternative embodiments, there may be a checklist of reviewers who must sign off on a project if the project requires certain capital or personnel investment. Alternatively, individuals with veto authority may be listed on such an approval checklist. In alternative embodiments, one person may have the authority to determine the consensus on a proposal and make a final determination based on the reviewers comments. In still further embodiments, there may be a face to face meeting of the review team to reach a final consensus.

Once each reviewer has had the opportunity to review the proposal and submit comments, the project proposal stage may be complete. At this point the proposal may be implemented, put on hold for a change of circumstances or canceled 45 (FIG. 3). If the project is put on hold or canceled this will complete the review process 47 (FIG. 3) of the present invention; no more documentation will need to be generated regarding the proposal and the proposal will be flagged as rejected. As previously noted, however, the proposer may utilize the comments and other information to refine the proposal for re-submission. If the proposal is approved, it becomes an ongoing project 50. An ongoing project then starts to gather the resources, funding, personnel, etc. to begin the implementation of the proposal.

The summary sheet may not have all of the specific information required to actually implement the project. The simplified summary sheets illustrated herein focused on the broad aspects of the proposal, including goals, the basic outline of how the proposal intends to meet those goals, and the resources required to meet the goals. An alternative embodiment may be utilized to gather the specific information and strategy details for the actual implementation of the proposal. Other documents from different proposal tools that are designed to track more detail may be attached or linked to the present invention, allowing access to all parameters through one proposal screen. The actual proposal implementation information may be reviewed by another reviewer who is familiar with the overall project, or a reviewer who may have a particular specialty in the implementation details of proposals.

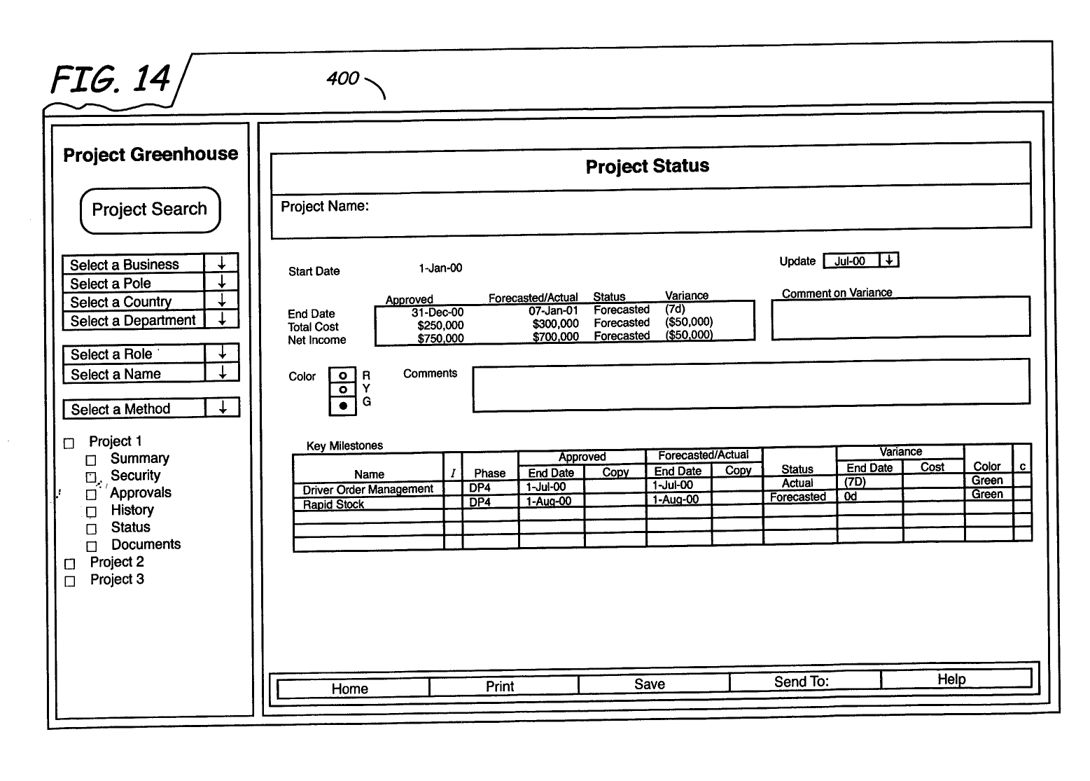

When a proposal becomes an ongoing project and is being implemented, the system may facilitate the ongoing review of the project parameters to help decide whether the project should be continued. A project status sheet 400 is illustrated in FIG. 14. The proposal, now an ongoing project, began to utilize company resources to achieve the stated goal. Periodic review of the project goals, implementation strategies and results achieved may be required by company policy. The ongoing review and approval, sometimes known as “tollgate” approval, may be required to check off on the project at each stage of the proposal implementation. The reviewers may check to see if the company is getting what they expected when the proposal was approved for implementation. The system provides an easy platform for this ongoing project review.

Review of an ongoing project with the present invention may have several advantages. It may allow the reviewers to observe through the project summary the stated goals of the project, the projected capital and personnel investment, and projected revenues. Each time new project information is submitted and reviewed at various stages in the project, the project documents may be frozen and saved in order to be accessible by future reviews. In addition, the frozen proposal, or the project parameters from a prior review, may be recalled to refresh the reviewer on the reasons why the project was originally approved for implementation. In this way, a reviewer may be better able to decide if the project is successfully meeting the designated performance criteria. As previously noted, if the project has changed the implementation goals or methods, those changed parameters are frozen and may be recalled to allow comparison of the updated parameters to the present conditions.

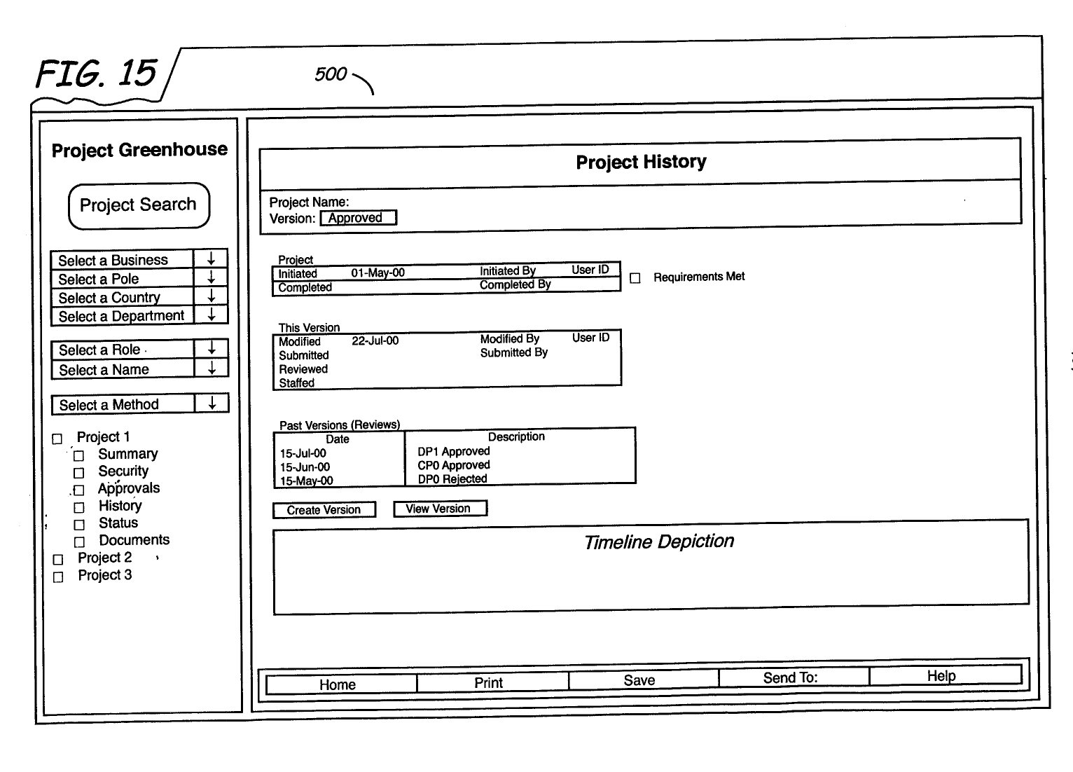

A project history page 500, as illustrated in FIG. 15, may chronicle the number of times the project has been reviewed since it was first proposed. Easy tabulation of the history of the project allows easy access to information which allows an evaluation of how the project is changing to meet changing circumstances, and how the project is meeting its stated goals.

The system ensures different reviewers have access to the same information on the project, allows easy communication among reviewers, and achieves other goals. The system also allows the original proposal and each change in the ongoing project to be easily accessed through the server. Efficient and complete access to information by each of the different reviewers allows an efficient comparison of the project evaluation criteria to the current project levels. Each project parameter set out at each review may be saved and recalled for comparison purposes during later reviews.

Alternative embodiments may have a feature that allows the tracking of types of projects. Tracking the types of projects allows the company to see if some areas are getting more attention than other areas, for example, if more growth projects are being implemented than personnel projects. The ability to track a company's project portfolio by type of project may allow the company to better align its projects with the company's overall business plan.

The project list such as shown in FIGS. 5, 6 and 8 may also have further features that allow reviewers to track projects that are currently being implemented. In one embodiment, the information for each project may appear in different colors depending on the status of the project. If a project is meeting its goals and is not in need of a strenuous and thorough review, the project may be flagged green by a project manager. If a project is starting to fall behind in meeting its performance criteria, and needs to have a more thorough review, the project may be flagged yellow. A red flag on a project may indicate that a project is in serious trouble because of some inherent problems. This page may also illustrate to an executive officer of the company how the overall company's effectiveness looks in implementing ongoing projects. In still further embodiments, a variety of ways to indicate the urgency of a project implementation review may be utilized.

In an alternative embodiment the red-yellow-green system may be utilized in different ways. In one embodiment, the various colors could be linked to the variance between the proposal schedule, cost, net benefit and the ongoing project's achievement of its goals. A red marking would indicate a non-zero variance between the approved outlook and the actual achievement, while a green would indicate equality between the same. In still further embodiments, the present invention may have the ability to track and save the variance from month to month, tracking not only the red-yellow-green status of the project, but also the actual variance between projected and realized goals for each different parameter, along with underlying reason.

In alternative embodiments, baselines for cost and net benefit may be set with the help of a financial person. In this manner, the projected baseline would not be set until input has been incorporated of someone with experience in setting man power, cost, capital, etc. requirements. In this manner, more realistic goals may be set and ultimately achieved.

In alternative embodiments a text search tool may be provided for use with the system. The text search capability may allow the search of all the proposals and projects saved on the present embodiment, and the text contained therein, for certain keywords or phrases. This may allow a proposer who is starting work on a new project to search the system for similar proposals. Being able to leverage past experience prevents the company from having to proverbially “reinvent the wheel” every time a new situation arises or a new proposal is being created.

The system may provide a central clearinghouse for proposals that are to be reviewed or have been reviewed. A central repository of proposals and ongoing projects of this kind may allow a company to better leverage its experience. The company may combine resources for similar projects, expand projects geographically to other areas that may have the same need, or build on past proposals and projects to more quickly meet changing circumstances. Furthermore, company officials may also use this database to plan overall business strategy based on the ongoing proposals and projects.

The system may also provide better final overall project review. If a project does happen to fail, the frozen proposal and project reviews will present an easy method to review the project implementation for failure analysis.

The system may also provide an easy and standard template for the submission of proposals. Having a standard template for the submission of proposals on a company wide basis allows the efficient formation of proposals because each proposer knows exactly what type of information must be submitted, and in what format it should be submitted.

The system may include a layered review system. If a proposal is heavily dependent on financial numbers or other information that may be tedious to analyze, it may be earmarked for analysis by someone who specializes in such analysis before submission to the one or more reviewers. The reviewers do not have to then personally examine detailed numerical analysis; each reviewer can instead perform an overall strategy evaluation.

While the present invention has been described with reference to several embodiments thereof, those skilled in the art may recognize various changes that may be made without departing from the spirit and scope of the claimed invention. Accordingly, this invention is not limited to what is shown in the drawings and described in the specification. Any number or ordering of the elements is merely for convenience and is not intended to suggest that the ordering of the elements has any particular significance other than that otherwise explicitly expressed.

1. A method for tracking projects comprising:
providing a project summary screen;
receiving proposal parameters;
freezing the proposal parameters;
presenting the proposal parameters to at least one reviewer; and
receiving a decision regarding the proposal parameter from the at least one reviewer.

2. The method of claim 1, further comprising:
receiving revisions to the proposal parameters prior to freezing the proposal parameters.

3. The method of claim 1, further comprising:
receiving a designation of reviewers.

4. The method of claim 1, further comprising:
unfreezing the proposal parameters after receiving a decision so as to allow revisions to the proposal parameters.

5. The method of claim 1, further comprising:
receiving comments from the at least one reviewer regarding the proposal parameters;
storing the comments with the proposal parameters; and
presenting the comments along with the proposal parameter to a subsequent reviewer.

6. The method of claim 1, further comprising:
converting the proposal to a project after receiving a decision; and
tracking the progress of the project.

7. The method of claim 6, further comprising:
indicating the status of the project based on automatic comparison to previously approved parameters.

8. The method of claim 7, wherein indicating the status of the project includes color coding project parameters.

9. The method of claim 1, further comprising:
receiving attached documents;
storing the attached documents; and
presenting the attached documents to the reviewer.

10. A method for submitting a project proposal comprising:
initiating a proposal idea;
formulating goals and objectives for the proposal;
entering proposal parameters in to a system for tracking proposals; and
receiving a decision regarding the proposal.

11. The method of claim 10, further comprising:
selecting reviewers for the proposal.

12. The method of claim 10, further comprising:
receiving an indication that the proposal will not move forward in a current form;
revising the proposal; and
resubmitting the revised proposal through the system for tracking proposals.

13. A system for tracking proposals comprising:
a server for presenting a project summary screen and receiving proposal parameters; and
a database for storing the project parameters and providing the proposal parameters when requested.

14. The system of claim 13, wherein the server is configured to freeze the proposal parameters stored in the database.

15. The system of claim 13, wherein the server presents the proposal parameters to reviewers.

16. The system of claim 15, wherein the server receives and stores comments from the reviewers.

17. The system of claim 16, wherein the comments are presented along with the proposal parameters to subsequent reviewers.

18. The system of claim 15, wherein the server receives a decision regarding the proposal parameters from the reviewers.

19. The system of claim 18, wherein the server unfreezes the proposal parameters and allows the proposal parameters to be revised.

20. A system for tracking proposals comprising:
means for receiving proposal parameters;
means for presenting the proposal parameters to reviewers; and
means for freezing the proposal parameters so that each reviewer reviews the same proposal parameters.

21. The system of claim 20, further comprising:
means for selecting the reviewers.

22. The system of claim 20, further comprising:
means for receiving a decision from the reviewers.

23. The system of claim 22, further comprising:
means for unfreezing the proposal parameters to allow for revision.

24. The system of claim 20, further comprising:
means for converting the proposal to a project; and
means for tracking the project.

25. The system of claim 24, further comprising:
means for visually indicating the status of project parameters based on automatic comparison to previously approved parameters.

26. The system of claim 20, further comprising:
means for receiving attached documents with the proposal parameters; and
means for presenting the attached documents to the reviewers.
